(19) United States
(12) Patent Application Publication
(10) Pub. No.: US 2010/0162224 A1
(43) Pub. Date: Jun. 24, 2010

(54) NODE UPDATE SYSTEM USING VIRTUAL PARTITION TECHNIQUE AND CONTROL METHOD THEREOF

(75) Inventors: Jang Sik Bae, Daegu (KR); Gwang Su Kim, Daejeon (KR); Ho Geun Lee, Daejeon (KR); Kyu Hyung Kim, Daegu (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/543,931

(22) Filed: Aug. 19, 2009

(30) Foreign Application Priority Data
Dec. 18, 2008 (KR) 10-2008-0129635

(51) Int. Cl. G06F 9/44

(52) U.S. Cl. 717/170; 717/171; 711/103

(57) ABSTRACT

Provided are a node update system using virtual partition technique and a control method thereof. A storage region of a sensor node is divided into a non-updatable invariable region and an updatable variable region to be virtually generated according to an execution operation of the sensor node. The states of the sensor nodes are monitored, and an update request signal is transmitted to a corresponding sensor node when update is necessary. Execution image information is received, and the execution image information is stored in the variable region to update an execution image, according to a response signal to the update request signal.

### CROSS-REFERENCE TO RELATED APPLICATIONS

This application claims priority under 35 U.S.C. §119 to Korean Patent Application No. 10-2008-0129635, filed on Dec. 18, 2008, in the Korean Intellectual Property Office, the disclosure of which is incorporated herein by reference in its entirety.

### TECHNICAL FIELD

The following disclosure relates to a node update system, and in particular, to a node update system and control method thereof, which update only the necessary portion of an execution image without updating the entirety of the execution image by using a virtual partition, in updating the execution images of sensor nodes constituting a wireless sensor network.

### BACKGROUND

Generally, a wireless sensor network technology disposes tens to tens thousands sensor nodes according to needs, and denotes a technology where the sensor node transmits sensing information, which is generated according to a predetermined condition, to a management server or an upper application server through a sink node or a router.

In such a wireless sensor network technology, the number of sensor nodes which actually constitute a network is at least hundreds to tens of thousands, and the sensor nodes are mainly disposed in a position where it is difficult to maintain and manage them in their operation characteristics.

Particularly, when an execution image is updated for updating an operation on a portion or entirety of the sensor node in the wireless sensor network, a method of using a wired interface such as a serial port and a parallel port is not suitable because of the characteristics of the sensor node.

Accordingly, a method is required which updates an execution image using a wireless communication without passing through the wired interface of a sensor node.

However, a method of updating the execution image of a sensor node using a wireless communication updates up to a reusable portion of an execution image in the existing sensor node because of using a method that transmits the entirety of a new execution image to thereby update it. Accordingly, the method of updating wastes time by updating a portion unnecessary, thereby decreasing efficiency for update.

### SUMMARY

In one general aspect, a node update system using virtual partition technique for updating execution images of a plurality sensor nodes constituting a wireless sensor network includes: an update management server transmitting an update request signal for the performance of the update procedure, and transmitting execution image information to be stored in a variable region of the sensor node to a corresponding sensor node to control an update of the corresponding sensor node upon reception of a response signal.

The node update system may further include a sink node connected to the update management server for wirelessly transmitting an update request signal or execution image information to a corresponding sensor node; and a plurality of sensor nodes configured to determine whether updating is necessary according to the update request signal, and perform an update procedure of an execution image based on the execution image information, in response to receiving the execution image information.

The sensor node may include a program storing unit for generating a virtual partition region of a non-updatable invariable region and an updatable variable region.

The program storing unit may be implemented with at least one of flash Read-Only Memory (ROM) and Electronically Erasable Programmable Read-Only Memory (EEPROM).

A user program may be stored in the variable region, and a system library used by the user program may be stored in the invariable region.

The system library of the invariable region may not be varied by a change of the user program.

The execution image information of the sensor node may include a plurality of records, each of the plurality of records including a start code field, a byte count field, an address field, a data field, and a checksum field.

The sensor node may store received execution image information in a memory region designated by information included in the address field.

The sensor node may determine whether to perform an update procedure based upon a version of execution image information included in the received update request signal.

In another general aspect, a control method of a node update system using virtual partition technique for updating execution images of a plurality sensor nodes constituting a wireless sensor network includes: virtually generating an invariable region which cannot be updated and an updatable variable region into which a storage region of a sensor node is divided, according to an execution operation of the sensor node; monitoring states of the sensor nodes, and transmitting an update request signal to a corresponding sensor node when update is necessary; and receiving an execution image information which is transmitted, and storing the execution image information in the variable region to update an execution image, according to a response signal to the update request signal.

The control method may further include determining whether an update procedure is performed based upon a version of execution image information included in the update request signal, and changing to an update mode; and changing to a general mode, and transmitting an update end signal representing an end of an update operation, when the update procedure is completed.

A user program may be stored in the variable region, and a system library used by the user program may be stored in the invariable region.

The system library of the invariable region may not be varied by a change in the user program.

The execution image information may include a plurality of records including a start code field, a byte count field, an address field, a data field, and a checksum field.

Updating the execution image may include designating a region, in which received execution image information is to be stored, by information included in the address field.

Other features and aspects will be apparent from the following detailed description, the drawings, and the claims.

### BRIEF DESCRIPTION OF THE DRAWINGS

FIG. 1 is a block diagram illustrating a node update system using a virtual partition technique according to an exemplary embodiment.

FIG. 2 is a diagram illustrating a format of execution image information according to an exemplary embodiment.

FIG. 3 is a diagram illustrating a storage region for a virtual partition technique in a sensor node according to an exemplary embodiment.

FIG. 4 is a flowchart illustrating a node update operation in the sensor node according to an exemplary embodiment.

FIG. 5 is a flowchart illustrating a signal flow in the node update system using the virtual partition technique according to an exemplary embodiment.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/of systems described herein will be suggested to those of ordinary skill in the art. Also, descriptions of well-known functions and constructions may be omitted for increased clarity and conciseness.

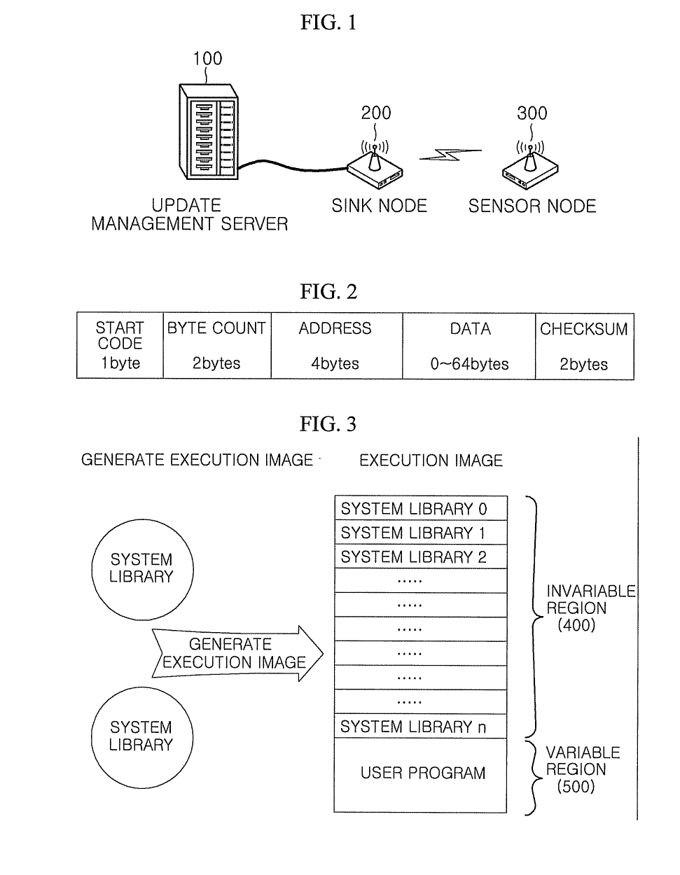

FIG. 1 is a block diagram illustrating a node update system using a virtual partition technique according to an exemplary embodiment. FIG. 2 is a diagram illustrating a format of execution image information according to an exemplary embodiment. FIG. 3 is a diagram illustrating a storage region for a virtual partition technique in a sensor node according to an exemplary embodiment.

Referring to FIG. 1, the node update system according to an exemplary embodiment includes an update management server 100, a sink node 200, and a sensor node 300.

The update management server 100 monitors the state of the remote sensor node 300 by a wireless communication. When the update of the sensor node 300 is necessary as a result of the monitoring or self-determination, the update management server 100 transmits an update request signal for the performance of an update procedure through the sink node 200, and transmits execution image information to the sink node 300 via the sink node 200 to thereby control the update of the sink node 300 upon reception of a response signal (permission).

As shown in FIG. 2, the execution image information is composed of a plurality of records including a start code field of 1 byte, a byte count field of 2 bytes, an address field of 4 bytes, a data field of 0-64 bytes and a checksum field of 2 bytes. Herein, the address field includes a memory address, which is in the sensor node 300, to store received execution image information.

The sink node 200 is connected to the update management server 100 through a serial interface and transmits the transmitted update request signal or the transmitted execution image information to the sensor node 300 in a wireless manner.

The sensor node 300 determines whether to update according to the update request signal and thereby transmits a response signal (for example, a signal indicating permission or rejection). Upon reception of the execution image information, the sensor node 300 performs the update procedure of the execution image on the basis of the execution image information.

When the version of the update-requested execution image is higher than that of an execution image which is currently being executed in the sensor node 300, the sensor node 300 transmits a response signal (for example, a signal indicating rejection) to the update management server 100. On the other hand, when the version of the update-requested execution image is not higher than that of the execution image and is a previous version (or the same version), the sensor node 300 transmits a response signal (for example, a signal indicating rejection) to the update management server 100.

Moreover, as shown in FIG. 3, the sensor node 300 includes a program storing unit (not shown) generating the virtual partition region of a non-updatable invariable region 500 which cannot be updated and an updatable variable region 500, wherein the program storing unit may be implemented with at least one flash Read-Only Memory (ROM) or Electronically Erasable Programmable Read-Only Memory (EEPROM) which is a nonvolatile memory.

One or more user programs which are written in various formats are stored in the variable region 500 of the senor node 300, and a system library used by the user program is stored in the invariable region 400. A change of the user program is reflected in the system library of the invariable region 400, and thus, the system library of the invariable region 400 is not varied by the transmitted execution image information.

The following description will be made with reference to the accompanying drawings on the operation of the node update system according to an exemplary embodiment.

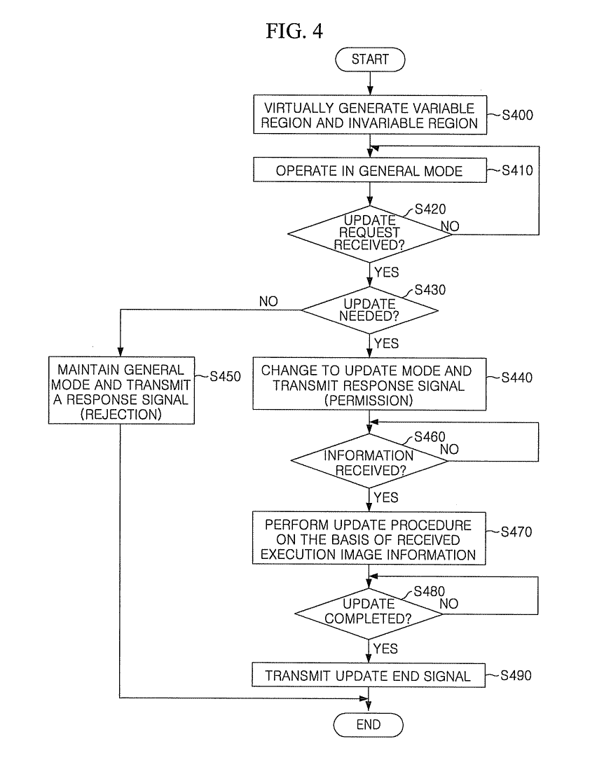

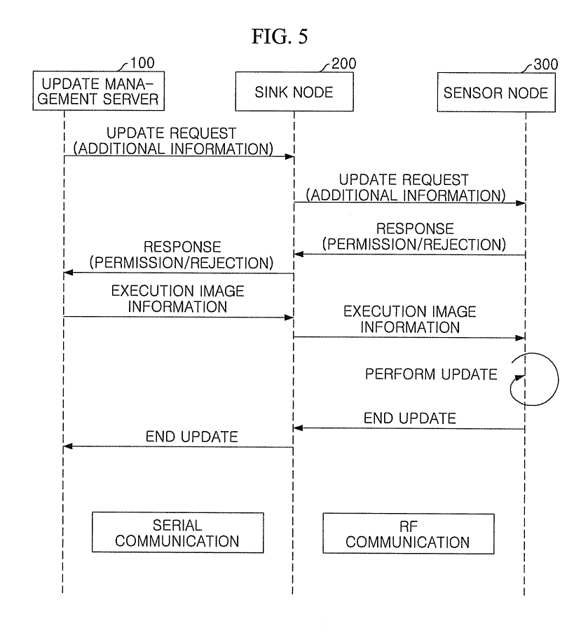

FIG. 4 is a flowchart illustrating a node update operation in the sensor node according to an exemplary embodiment. FIG. 5 is a flowchart illustrating a signal flow in the node update system using a virtual partition technique according to an exemplary embodiment.

Referring to FIGS. 4 and 5, the sensor node 300 virtually generates the invariable region 400 which cannot be updated and the updatable variable region 500 into which the storage region of the program storing unit is divided, according to an execution operation in operation S400.

At this point, the user programs which are written in various formats are stored in the variable region 500, and the system library used by the user program is stored in the invariable region 400. The system library of the invariable region 400 is not varied by a change of the user program.

When update is necessary, the update management server 100 transmits an update request signal to the sensor node 300 through the sensor node 200.

Accordingly, the sensor node 300 operates in a general mode in operation S410. At this point, when the update request signal is received during the performance of the general mode in operation S420, the sensor node 300 determines whether update is necessary according to the version of execution image information included in the received update request signal in operation S430.

When the determination result in operation S430 shows that the version of the execution image information is higher than that of an execution image which is currently being executed in the sensor node 300, the sensor node 300 changes to an update mode and simultaneously transmits a response signal (for example, a signal indicating permission) to the update management server 100 in operation S440.

When the determination result in operation S430 shows that the version of the execution image information is not higher than that of the execution image and is a previous version (or the same version), the sensor node 300 continuously maintains the general mode and transmits a response signal (for example, a signal indicating rejection) to the update management server 100 in operation S450.

When execution image information is received from the update management server 100 in operation S460, the sensor node 300 stores the received execution image information in one of the variable region 500 and the invariable region 400, thereby updating the execution image in operation S470.

As shown in FIG. 2, the received execution image information is composed of a plurality of records including the start code field, the byte count field, the address field, the data field and the checksum field. The sensor node 300 designates a region, in which the received execution image information is to be stored, by the information of the address field.

When the update procedure in operation S470 is completed in operation S480, the sensor node 300 changes the update mode to the general mode and simultaneously transmits an update end signal representing the end of the update operation to the update management server 100 in operation S490.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A node update system using virtual partition technique for updating execution images of a plurality sensor nodes constituting a wireless sensor network, the node update system comprising:
an update management server transmitting an update request signal for the performance of the update procedure, and transmitting execution image information to be stored in a variable region of the sensor node to a corresponding sensor node to control an update of the corresponding sensor node upon reception of a response signal.

2. The node update system of claim 1, further comprising:
a sink node connected to the update management server, wirelessly transmitting a received update request signal or execution image information to a corresponding sensor node; and
a plurality of sensor nodes determining whether updating is necessary according to the update request signal to transmit a response signal, and performing an update procedure of an execution image on the basis of the execution image information upon reception the execution image information.

3. The node update system of claim 2, wherein the sensor node comprises a program storing unit generating a virtual partition region of a non-updatable invariable region and an updatable variable region.

4. The node update system of claim 3, wherein the program storing unit is implemented with at least one of flash Read-Only Memory (ROM) and Electronically Erasable Programmable Read-Only Memory (EEPROM).

5. The node update system of claim 3, wherein one or more user programs which are written in various formats are stored in the variable region, and a system library used by the user program is stored in the invariable region.

6. The node update system of claim 5, wherein the system library of the invariable region is not varied by a change of the user program.

7. The node update system of claim 2, wherein the execution image information of the sensor node comprises a plurality of records comprising a start code field, a byte count field, an address field, a data field and a checksum field.

8. The node update system of claim 7, wherein the sensor node stores received execution image information in a memory region designated by information of the address field.

9. The node update system of claim 2, wherein the sensor node determines whether to performs an update procedure based on a version of execution image information comprised in the received update request signal.

10. A control method of a node update system using virtual partition technique for updating execution images of a plurality sensor nodes constituting a wireless sensor network, the control method comprising:
virtually generating a non-updatable invariable region and an updatable variable region into which a storage region of a sensor node is divided, according to an execution operation of the sensor node;
monitoring states of the sensor nodes, and transmitting an update request signal to a corresponding sensor node when update is necessary; and
receiving a transmitted execution image information, and storing the execution image information in the variable region to update an execution image, according to a response signal to the update request signal.

11. The control method of claim 10, further comprising:
determining whether an update procedure is performed by a version of execution image information comprised in the update request signal to transmit a response signal, and changing to an update mode; and
changing to a general mode, and transmitting an update end signal representing an end of an update operation, when the update procedure is completed.

12. The control method of claim 10, wherein one or more user programs which are written in various formats are stored in the variable region, and a system library used by the user program is stored in the invariable region.

13. The control method of claim 12, wherein the system library of the invariable region is not varied by a change of the user program.

14. The control method of claim 10, wherein in the updating of the execution image, the execution image information comprises a plurality of records comprising a start code field, a byte count field, an address field, a data field and a checksum field.

15. The control method of claim 14, wherein the updating of the execution image further comprises designating a region, in which received execution image information is to be stored, by information of the address field.
